(19) United States
(12) Patent Application Publication
(10) Pub. No.: US 2026/0104538 A1
(43) Pub. Date: Apr. 16, 2026

(54) HIDDEN VISUAL INDICATOR SYSTEM AND METHODS

(71) Applicant: DISNEY ENTERPRISES, INC., Burbank, CA (US)

(72) Inventors: Steven M. Chapman, Newbury Park, CA (US); Sidney Andrew Fox, Monrovia, CA (US); Rodrigo Antonio Banuelos Torres, Wilmington, CA (US)

(21) Appl. No.: 18/911,730

(22) Filed: Oct. 10, 2024

(51) Int. Cl. G02B 5/12; G06T 19/00

(52) U.S. Cl. CPC G02B 5/12; G06T 19/006

(57) ABSTRACT

A visual indicator assembly includes a retroreflective layer and a diffusion layer coupled to and positioned over at least a portion of the retroreflective layer. The diffusion layer reduces reflection of light from the retroreflective layer for at least one viewpoint relative to the visual indicator assembly.

### FIELD

The present application relates to systems and methods of calibration of entertainment and immersive systems, such as augmented reality (AR) systems.

### BACKGROUND

Immersive experiences, such as those including augmented reality (AR), generally utilize visualization, acoustics, or other sensory components, such as projectors, cameras, speakers, actuators, and the like to provide output (e.g., graphics, audio, etc.) to users within the immersive experience environment. As such technology advances, more precise alignment and calibration systems are needed to properly align and/or actuate the AR components (e.g., graphics or other visual, auditory, or sensory elements) with the real world environment. Currently, physical codes are often used to provide such calibration. For example, a visual indicator may identify point in physical space, allowing calibration of an AR component within the physical space. For example, calibration may align an effect or other output within space, adjust timing of an effect or other output, or the like. When properly calibrated, the AR component, or an AR system including multiple AR components, may properly display (e.g., at a desired location, time, etc.) AR elements or outputs within the real world environment. For example, graphics may be aligned as intended within the real world environment. However, such visual indicators, if not hidden or camouflaged from users, may distract users and detract from an immersive experience.

### BRIEF SUMMARY

A visual indicator assembly includes a retroreflective layer and a diffusion layer coupled to and positioned over at least a portion of the retroreflective layer. The diffusion layer reduces reflection of light from the retroreflective layer for at least one viewpoint relative to the visual indicator assembly.

In some examples, the diffusion layer reduces reflection of light in a visible light spectrum.

In some examples, the diffusion layer reduces reflection of light in an infrared spectrum.

In some examples, the diffusion layer allows reflection of light from the retroreflective layer from at least one angle relative to the visual indicator assembly.

In some examples, the visual indicator assembly includes a visual indicator, where the visual indicator is visible from the at least one angle.

In some examples, the at least one angle is perpendicular to a surface of the visual indicator assembly.

In some examples, the retroreflective layer comprises a retroreflective base layer and a retroreflective component layer, where the retroreflective base layer includes a visual indicator.

In some examples, the visual indicator is an augmented reality (AR) code.

In some examples, the diffusion layer is a pure-diffuse enamel layer.

In some examples, the visual indicator is an AR code.

A method of utilizing a visual indicator assembly includes providing a visual indicator assembly. The visual indicator assembly includes a visual indicator with a retroreflective layer and a diffusion layer coupled to and positioned over at least a portion of the retroreflective layer, The diffusion layer reduces reflection of light from the retroreflective layer for at least one viewpoint relative to the visual indicator assembly. The method includes illuminating the visual indicator at a first angle relative to the at least one viewpoint.

In some examples, the at least one viewpoint is at a second angle relative to the visual indicator assembly, the method further include masking a reflection of light from the visual indicator at the second angle.

In some examples, the first angle is perpendicular to a surface of the visual indicator assembly and the second angle is not perpendicular to the surface of the visual indicator assembly.

In some examples, illuminating the visual indicator at the first angle includes illuminating the visual indicator with light in a visible light spectrum.

In some examples, illuminating the visual indicator at the first angle includes illuminating the visual indicator with light in an infrared light spectrum.

In some examples, the visual indicator is visible when the visual indicator is illuminated from the first angle.

In some examples, the visual indicator is an augmented reality (AR) code.

In some examples, the method further includes aligning at least one AR component based on the AR code.

In some examples, the diffusion layer is a pure-diffuse enamel layer.

A method for mapping placement of one or more visual indicators within an environment includes identifying a light path of at least one light source within an environment, identifying locations within the environment outside of the identified light path, and outputting the locations as positions for the one or more visual indicators.

In some examples, the identified light path is within at least one expected viewing angle of the one or more visual indicators.

### BRIEF DESCRIPTION OF THE SEVERAL VIEWS OF THE DRAWINGS

FIG. 1 illustrates an example visual indicator assembly.

FIG. 2A illustrates an example visual indicator assembly.

FIG. 2B illustrates a section view of a portion of the visual indicator assembly of FIG. 2A taken along line 2B-2B of FIG. 2A.

FIG. 3 is a flow chart illustrating an example process for utilizing a visual indicator.

FIG. 4 is a flow chart illustrating an example process for mapping placement of visual indicators within an environment.

FIG. 5 is a flow chart illustrating an example process for utilizing a visual indicator assembly.

FIG. 6 is an example computing system used in various examples of the disclosure.

### DETAILED DESCRIPTION

Various immersive elements, such as AR outputs, may be incorporated into many environments, such as amusement park rides, walk-through environments and experiences, and the like. For example, AR elements or outputs can be used to create the experience of a fictional environment by the use of video, audio, and other sensory outputs. To provide a more fully immersive experience, AR components providing AR outputs, such as projectors, personal devices, speakers, physical components such as animatronics, and the like must be calibrated within the environment. In many examples, cameras or other visual sensors (e.g., barcode scanners or lasers) are utilized to locate AR identifiers, such as markers or codes, which can provide information about the location of the AR marker or code within space. For example, AR markers may, when scanned by a camera, be utilized to calibrate other components of AR systems such that AR outputs appear to be properly aligned within the environment. However, such AR markers may be visible by users within an environment, detracting from the immersive experience provided by AR outputs.

Traditional AR markers may be hidden within an environment in an attempt to conceal such markers from viewers, e.g., to maintain the immersive experience and prevent guests from “seeing behind the magic.” However, concealing such markers in corners or less prominent locations may make the markers less visible by AR components, i.e., less easily identifiable by the system. When the AR markers are less visible by AR components, calibration of AR components is more difficult and more likely to be incorrect, this can lead to effects being misaligned and/or mistimed, which can act to detract from the immersive experience. Other solutions, such as hidden controllable lighthouses, may be expensive to incorporate into various environments. For example, a hidden controllable lighthouse may include complex components that are difficult to implement and/or maintain when integrated into components of the environment.

The systems and methods described herein may be utilized to provide concealed visual indicators for use in calibration, incorporation of AR or other effects within an environment, gaming within an environment, or the like. For example, calibration may align an effect or other output (e.g., AR projections, audio outputs, scent, actuation of physical components, or the like) within space or time. Such visual indicators may include identifiers such as AR codes, which provide information which can be utilized to mark a location in space and/or to provide location information. For example, an AR code may provide information regarding where the AR code is relative to other objects in the environment, a relative orientation of the AR code within the environment, and the like. Such information may be utilized by AR components to align within the environment. The concealed visual indicators described herein may generally be highly visible by AR components while being less visible by viewers within an environment. The visual indicators may further be less expensive than other calibration solutions, such as hidden controllable lighthouses.

The systems and methods described herein may be applicable to attractions, such as amusement park attractions, AR gaming environments, and the like. For example, the concealed visual indicators described herein may be utilized in environments combining video game graphics with real-world sets. While the systems and methods herein are described with respect to AR based experiences, visual indicator assemblies disclosed herein may be utilized in other applications, such as scanning of quick response (QR) codes or other visual indicators used to convey information within an environment.

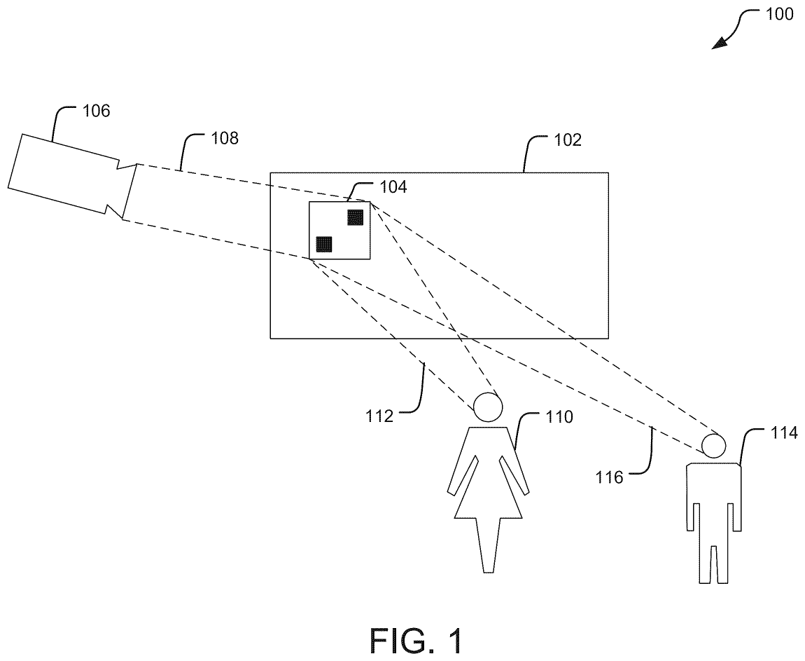

Turning to the drawings, FIG. 1 illustrates an example visual indicator assembly 102. The visual indicator assembly 102 is generally placed or located within an environment 100. The environment 100 may be, in various examples, an amusement park attraction, AR gaming environment, a display or exhibit, or other environment utilizing AR. The visual indicator assembly 102 generally includes a visual indicator 104 which provides information to an AR component 106 within the environment 100. For example, the visual indicator 104 may provide calibration information to the AR component 106. The AR component 106 may generally be part of an AR system utilized to provide an immersive experience to users 110 and 114 within the environment 100. For example, the visual indicator 104 may be utilized to align a projector to or other display to align visual output within space. In other examples, a visual indicator may be utilized to properly time an effect based on the positioning of users within the environment or other factors. For example, a visual indicator 104 may utilized to provide information to components on a ride vehicle to time effects such as actuation of set components, sounds, scents, or other types of outputs relative to the location of the ride vehicle within the environment 100.

In various examples, the visual indicator assembly 102 may generally be hidden or camouflaged within the environment 100. For example, the visual indicator assembly 102 may be colored or otherwise configured to blend in with the environment (e.g., the visual indicator assembly 102 may be coated with a black coating in a dark environment). In some examples, the visual indicator assembly 102 may be otherwise patterned, colored, or otherwise configured to otherwise blend into or form a portion of the environment 100. For example, the visual indicator assembly can be patterned or shaped to blend in with a particular background (e.g., may have a leaf pattern in a forest scene) or may be designed to form a portion of the environment 100 (e.g., may be designed to look like a painting hanging on a wall).

Various types of AR components 106 may obtain information from the visual indicator 104. For example, AR components 106 may include standalone cameras in communication with other AR components or other types of AR components 106 including cameras or other visual sensors, such as projectors, AR headsets or other wearables, personal electronic devices (e.g., smartphones), speakers, mechanical components (e.g., animatronics), or other types of AR displays. In various examples, cameras (either standalone or integrated cameras) or other visual sensors may identify or sense information from the visual indicator, which may be processed and utilized by other AR components 106 providing output to calibrate such AR components 106. For example, a smartphone may include a camera utilized to obtain information from the visual indicator 104. Similarly, projectors within an environment (e.g., ceiling mounted projectors within a ride environment) may include cameras utilized to obtain information from the visual indicator 104. In some examples, an AR component 106 may be a standalone camera in communication with a centralized processor. The centralized processor may communicate calibration information obtain by the standalone camera from the visual indicator 104 to one or more other components of an AR system, such as projectors, displays, or the like. Generally, an AR component 106 includes at least a light source and a visual sensor (e.g., visible light or IR camera).

Generally, the visual indicator 104 is visible by the AR component 106, while remaining concealed from or otherwise visually de-emphasized to the users (e.g., guests) 110 and 114 within the environment 100. For example, the visual indicator assembly 102 directs light reflecting off of the visual indicator 104. For example, the AR component 106 may include or be located near a light source to illuminate the visual indicator 104. For example, a camera may include a light to illuminate the visual indicator 104. Other such light sources may be built into or mounted other components of the environment 100, such as ride vehicles, walls, animatronics, or other pieces of a set of the environment 100. The light source may, in various examples, provide light in the visual spectrum or infrared (IR) spectrum. The light source may provide light to illuminate the visual indicator 104 such that the AR component 106 is able to obtain information from the visual indicator 104. For example, the AR component 106 may obtain calibration information (e.g., information about the location and/or orientation of the visual indicator 104 within the environment 100) from the visual indicator 104. For example, the light source may illuminate the visual indicator 104 at an angle relative to the visual indicator, where the angle is coincident with a field of view 108 of the AR component 106. In some examples, the visual indicator may be illuminated at an angle relative a viewpoint, such as a viewpoint of the AR component 106 and/or a user 110/114. The diffusion layer of the visual indicator assembly 102 may direct the light from the light source such that light is reflected from the visual indicator 104 at the angle of illumination, and the light is reflected in the field of view 108 of the AR component 106.

The visual indicator assembly 102 may further direct light such that light from the light source is masked or directed away from users 110 and 114 within the environment 100. For example, the user 110 may view the visual indicator 104 from a first viewing angle coincident with a field of view 112 of the user 110. Similarly, the user 114 may view the visual indicator 104 from a second viewing angle coincident with a field of view 116 of the user 114. The diffusion layer of the visual indicator assembly 102 directs light from the light source of the AR component 106 to reflect back to the AR component 106 at the angle of illumination from the light source. Such direction may mask the light from the light source from the first viewing angle and the second viewing angle, such that the users 110 and 114 see less of the light from the light source than would be visible without the diffusion layer. Accordingly, it may be difficult or impossible for the users 110 and 114 to see the visual indicator 104 from the first viewing angle and second viewing angle, respectively, effectively masking the visual indicator 104 from the view of the users 110 and 114. In various examples, the diffusion layer masks the visual indicator 104 at all viewing angles other than the angle of illumination from the light source of the AR component 106.

In various examples, one or more visual indicator assemblies 102 are placed within the environment 100 to reduce or eliminate overlap between the angle of illumination of the visual indicator 104 and the fields of view 112 and 116 of users 110 and 114. Such visual indicator assemblies 102 may further be placed to reduce or eliminate overlap between light paths of other light sources within the environment 100 and the fields of view 112 and 116 of the users 110 and 114. For example, light paths of various light sources within the environment 100 may be mapped, such that locations illuminated by such light sources are identified. One or more visual indicator assemblies 102 may be placed outside of such light paths, such that the visual indicators 104 are not illuminated by other light sources, which may make the visual indicators 104 visible to viewers.

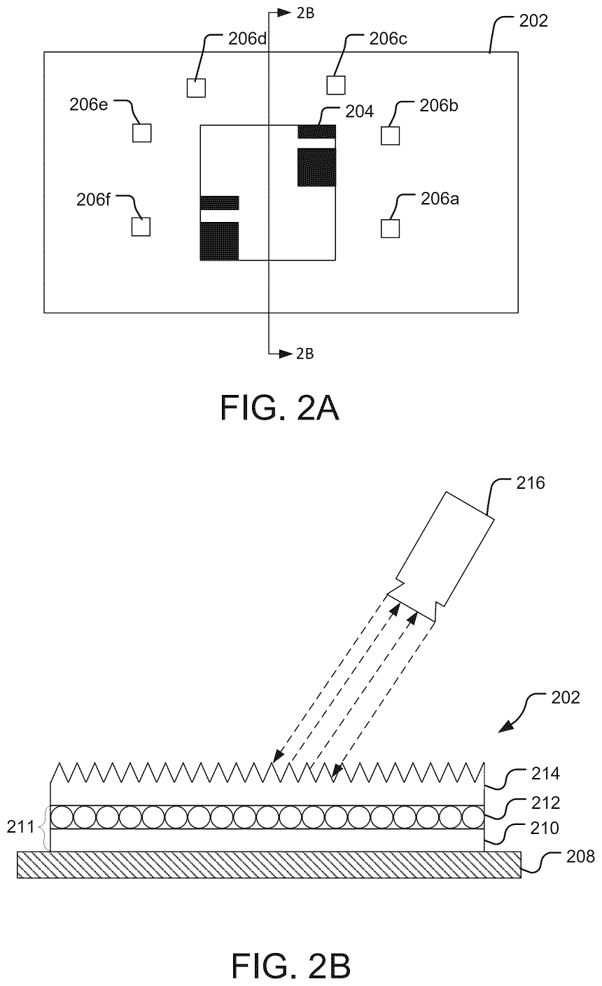

FIG. 2A illustrates an example visual indicator assembly 202. The visual indicator assembly 202 may be an example of the visual indicator assembly 102 described with respect to FIG. 1. The visual indicator assembly generally includes a visual indicator 204 and may include one or more supplementary visual indicators 206a-206f providing additional information to AR components within an environment. For example, a visual indicator 204 may provide information about a location within the environment of the visual indicator 204, while the one or more supplementary visual indicators 206a-206f may provide information about an orientation of the supplementary visual indicators 206a-206f relative to a location within the environment. In various examples, a visual indicator assembly 202 may include multiple visual indicators 204 and/or one or more supplementary visual indicators 206a-206f.

FIG. 2B illustrates a section view of a portion of the visual indicator assembly 202 of FIG. 2A, taken along line 2B-2B of FIG. 2A, such as a visual indicator 204 and/or a supplementary visual indicator 206a-206f. IAs shown in FIG. 2B, the visual indicator assembly 202 generally includes multiple layers. For example, the visual indicator assembly may include a substrate 208, a retroreflective layer 211, and a diffusion layer 214. In various examples, the retroreflective layer 211 may include a retroreflective base layer 210 and a retroreflective component layer 212.

The substrate 208 acts as a substrate or structure to other layers of the visual indicator assembly 202. The substrate 208 may be formed from various materials, including metals, wood, plastics, or the like. The substrate 208 has at least two sides, with one being coupled to a wall, set piece, or other structure, and the other receiving the other layers of the visual indicator assembly 202. In various examples, the substrate 208 may be configured (e.g., colored, shaped, patterned) to camouflage the visual indicator assembly 202 within an environment. For example, the substrate 208 may be black to conceal the visual indicator assembly 202 within a dark environment. The substrate 208 may, in other examples, include effects to draw viewer attention away from the visual indicator assembly 202, e.g., colored or reflective boarders that direct attention away from the area including the identifier. In another example, the substrate 208 may be patterned or otherwise colored to form a portion of the environment. For example, the substrate 208 may be patterned with tree branches in a forest scene.

The retroreflective layer 211 is generally coupled to and positioned over at least a portion of the substrate 208, e.g., may extend over an exterior or outwardly facing surface of the substrate 208. The retroreflective layer 211 includes the retroreflective base layer 210 and the retroreflective component layer 212. Visual indicators (e.g., visual indicator 204 and supplementary visual indicators 206a-206f) may be formed in the retroreflective layer 211. The retroreflective layer 211 may extend over only portions of the substrate 208 or may extend over the entire surface of the substrate 208. The retroreflective layer 211 generally brightens or enhances light shone onto the retroreflective layer 211, such that images made from such retroreflective material, such as the visual indicators described herein, appear brighter or more intense and are more easily seen or perceived by hardware components such as cameras or AR components 216. For example, the retroreflective component layer 212 may include glass beads that reflect back light to light sources illuminating the retroreflective layer 211.

The diffusion layer 214 is coupled to and positioned over at least a portion of the retroreflective layer 211 or the entirety of the retroreflective layer 211. The diffusion layer reduces the reflection of light from the retroreflective layer 211 for a plurality of viewpoints relative to the visual indicator assembly 202. In various examples, the diffusion layer 214 is a coating layered on top of the retroreflective layer 211. The coating may, in various examples, be a pure-diffuse enamel layer. The coating may be patterned or colored such that the visual indicator assembly 202 blends in with an environment or forms part of an environment. For example, in a dark environment, the coating may be black, such that the visual indicator assembly 202 appears to be black from various viewpoints relative to the visual indicator assembly 202. In another example, the coating may be patterned such that the visual indicator assembly 202 is camouflaged within an environment. In yet another example, the coating may be patterned or decorated such that the visual indicator assembly 202 forms a portion of the environment, such as appearing to be a painting hanging on a wall, a sign, wallpaper, or the like.

The diffusion layer 214 generally reflects light (e.g., visual light or light in the IR spectrum) back to a light source (e.g., AR component 216) directing light to the visual indicator assembly 202. The diffusion layer 214 further blocks such light from being reflected at other viewing angles relative to the visual indicator assembly 202. Accordingly, the retroreflective layer 211 is readily visible by such AR components 216 arranged at a set angle to the visual indicator assembly 202, without being visible by users viewing the visual indicator assembly 202 from other angles. Visual sensors of the AR component 216 can then to readily obtain information encoded in the retroreflective layer 211. For example, visual sensors of the AR component 216 can clearly view visual indicators 204, supplementary visual indicators 206a-206f, and any other visual indicators of the visual indicator assembly 202. For example, the visual sensors of the AR component 216 can sense light being reflected from the retroreflective layer 211 when the light is directed by the diffusion layer 214 when located at the set angle relative to the visual indicator assembly 202.

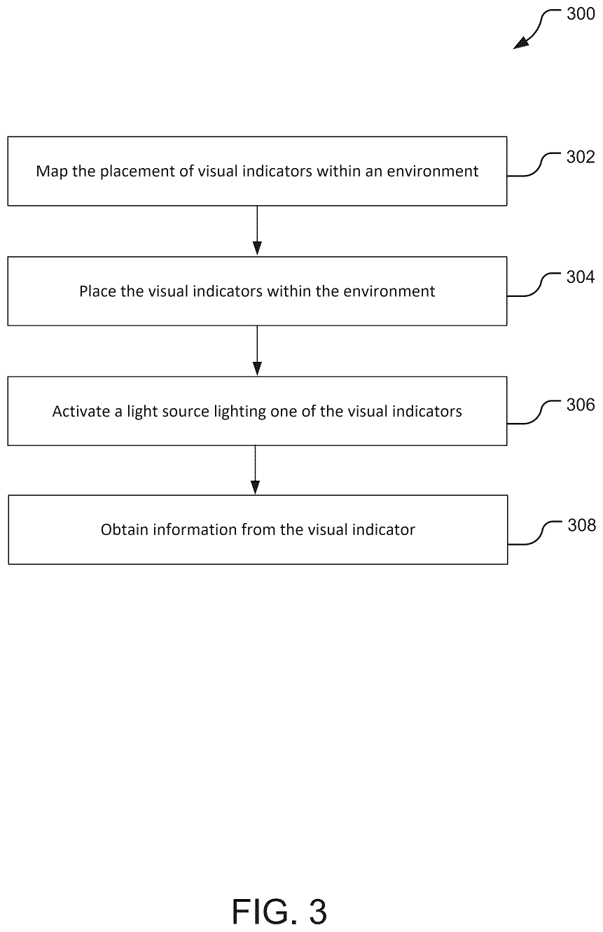

FIG. 3 illustrates an example process 300 for utilizing a visual indicator. At block 302 the placement of visual indicators within an environment is mapped. Such mapping is described with more detail relative to the process 400 herein. Generally, the mapping is utilized to find locations within the environment 100 where a visual indicator 104/204 or supplementary visual indicator 206a-206f will not be illuminated by an external light source, which may make the visual indicator 104 visible to users within the environment 100. Such an external light source may be a light source other than a light source of an AR component 106. Such mapping includes identifying light paths of light sources within the environment 100, identifying locations within the environment and outside of the identified light paths, and outputting the locations as positions for visual indicators.

The visual indicators 104 are placed within the environment at block 304. The visual indicators 104 may be placed at the locations within the environment 100 identified at block 302. The visual indicators (e.g., visual indicators 104) may be placed on a visual indicator assembly 102, and the visual indicator assembly 102 may be placed within the environment 100.

At block 306, a light source is activated. The light source lights one or more of the visual indicators 104/204 or supplementary visual indicator 206a-206f at an angle relative to the visual indicator assembly 102. The light source may be, in various examples, a light source of an AR component 106 and/or a light source proximate to an AR component 106. For example, the light source may be a visible light or IR component on a camera, personal electronic device, AR headset, or the like. Light from the light source passes through a diffusion layer 214 and is reflected back by a retroreflective layer 211 of the visual indicator assembly. For example, glass beads of a retroreflective component layer 212 may reflect light from the illuminated light source.

Information from the visual indicator is obtained at block 308. Visual indicators (e.g., visual indicators 104, 204, and/or secondary visual indicators 206a-206f) may be formed on or by the retroreflective layer 211. Accordingly, when light is reflected back from the retroreflective layer 211, the visual indicator is visible. The light is reflected by the retroreflective layer 211 and passes back through the diffusion layer 214. The diffusion layer 214 generally directs the reflected light at the original angle of incidence of the light. Because the light is directed back at the angle of incidence, the reflection of the light is reduced from angles other than the original angle of incidence. In some examples, the angle of incidence may be perpendicular to the visual indicator assembly, such that light reflected by the retroreflective layer 211 is visible from an angle perpendicular to the visual indicator assembly 202, and less or not visible from other angles relative to the visual indicator assembly 202.

Information from the visual indicator may be perceived by visual or IR sensors of AR components. For example, when light is reflected back to an AR component (e.g., AR components 106 and/or 216), sensors of the AR component may sense the light and obtain information from the pattern of the light (e.g., a pattern formed by the visual indicator or multiple visual indicators). Such information may, in various examples, include information utilized to calibrate or align AR components, such as location and/or orientation information.

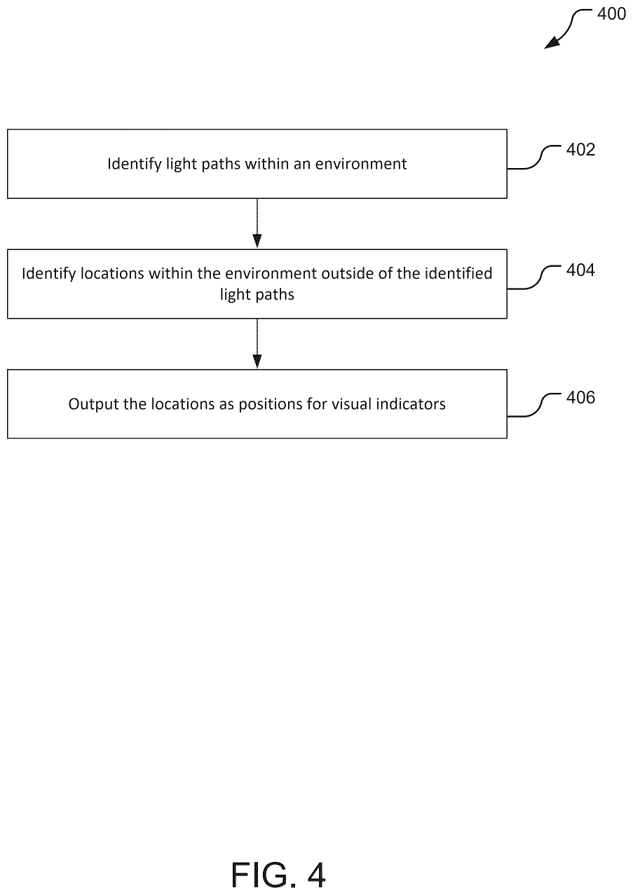

FIG. 4 illustrates an example process 400 for mapping placement of visual indicators within an environment. In various examples, the process 400 may be performed by a computing device provided with a model or models of the environment 100, structures within the environment 100, one or more light sources within the environment 100, expected viewing locations of users within the environment 100, and the like.

Light paths are identified within an environment at block 402. A light path may be an area of an environment expected to be illuminated when a particular light source is illuminated. In various examples, light paths within an environment 100 may include light paths from external light sources (e.g., light sources other than those of the AR components 106). Light paths may be identified based on location and orientation of light sources, expected light beam spread from various light sources, expected light intensity from various light sources, obstructions within the environment, and other characteristics of the light sources and/or the environment.

In some examples, the light paths may be light paths from light sources expected to be within viewing angles of users within the environment 100. For example, where the environment 100 includes a ride where viewing angles are known, such viewing angles may be considered such that light paths not expected to be seen by users (e.g., riders) are not identified at block 402. Viewing angles may be determined based on, for example, expected location and/or orientation of ride vehicles within an environment 100.

At block 404, locations within the environment 100 outside of the identified light paths are identified. In some examples, the locations may further be determined based on estimated positions of AR components 106 within the environment 100. For example, such locations may further be within expected light paths of AR components 106. Such locations are generally locations for placement of visual indicators such that the visual indicators are visible by AR components 106 but are not illuminated by external light sources such that the visual indicators would be easily visible by users within the environment 100. In various examples, a location may include both a point or area within the environment and an angle or orientation within the environment. For example, the angle or orientation may be chosen such that a light path of an AR component 106 is perpendicular to a visual indicator assembly 102.

The locations are output as positions for visual indicators at block 406. The locations may, in various examples, be output via a user interface and may be mapped within a model of the environment 100, output as coordinates, or the like. Using such positions, an engineer, a designer, or the like may determine where to place visual indicators 104 within an environment 100 so that the visual indicators are less likely to be perceived by users within the environment 100.

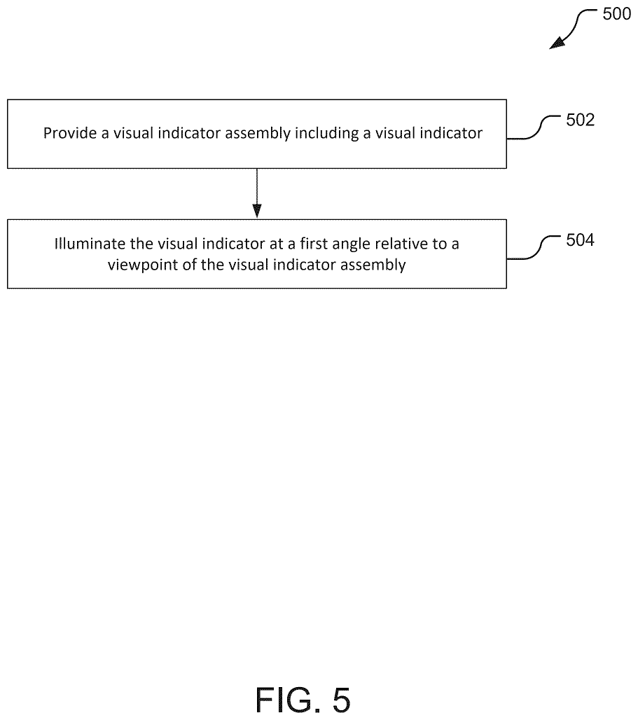

FIG. 5 illustrates an example process 500 for utilizing a visual indicator assembly within an environment. In various examples, the process 500 may be performed by a computing device provided with a model or models of the environment 100, structures within the environment 100, one or more light sources within the environment 100, expected viewing locations of users within the environment 100, and the like.

In block 502, the process 500 provides a visual indicator assembly 102/202. The visual indicator assembly 102/202 includes a visual indicator 104/204 with a retroreflective layer 211 and a diffusion layer 214 coupled to and positioned over at least a portion of the retroreflective layer 211. The diffusion layer 214 reduces reflection of light from the retroreflective layer 211 for at least one viewpoint relative to the visual indicator assembly 102/202.

In block 504, the process 500 illuminates the visual indicator at a first angle relative to the at least one viewpoint. In some examples, the first angle may be perpendicular to a surface of the visual indicator assembly, while an angle of the at least one viewpoint may be at a non-perpendicular angle with respect to the visual indicator assembly.

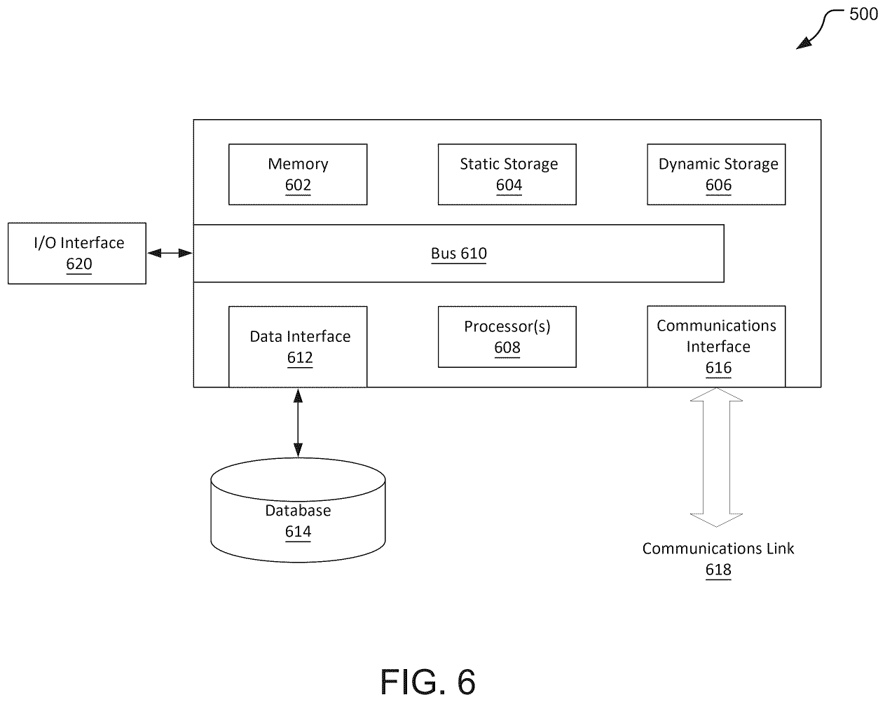

FIG. 6 illustrates an example computing system 600 that may be used for implementing various embodiments in the examples described herein. For example, in various embodiments, components of the systems used to map placement of visual indicators may be implemented by one or several computing systems 600. This disclosure contemplates any suitable number of computing systems 600. For example, the computing system 600 may be a server, a desktop computing system, a mainframe, a mesh of computing systems, a laptop or notebook computing system, a tablet computing system, an embedded computer system, a system-on-chip, a single-board computing system, or a combination of two or more of these. Where appropriate, the computing system 600 may include one or more computing systems; be unitary or distributed; span multiple locations; span multiple machines; span multiple data centers; or reside in a cloud, which may include one or more cloud components in one or more networks.

Computing system 600 includes a bus 610 (e.g., an address bus and a data bus) or other communication mechanism for communicating information, which interconnects subsystems and devices, such as one or more processor(s) 608, memory 602 (e.g., RAM), static storage 604 (e.g., ROM), dynamic storage 606 (e.g., magnetic or optical), communications interface 616 (e.g., modem, Ethernet card, a network interface controller (NIC) or network adapter for communicating with an Ethernet or other wire-based network, a wireless NIC (WNIC) or wireless adapter for communicating with a wireless network, such as a WI-FI network), input/output (I/O) interface 620 (e.g., keyboard, keypad, mouse, microphone). In particular embodiments, the computing system 600 may include one or more of any such components.

In particular embodiments, processor 608 includes hardware for executing instructions, such as those making up a computer program. For example, a processor 608 may execute instructions for various components of a biomarker analysis system. The processor 608 circuity includes circuitry for performing various processing functions, such as executing specific software for performing specific calculations or tasks. In particular embodiments, I/O interface 620 includes hardware, software, or both, providing one or more interfaces for communication between computing system 600 and one or more I/O devices. Computing system 600 may include one or more of these I/O devices, where appropriate. One or more of these I/O devices may enable communication between a person and computing system 600.

In particular embodiments, the communications interface 616 includes hardware, software, or both providing one or more interfaces for communication (such as, for example, packet-based communication) between computing system 600 and one or more other computer systems or one or more networks. One or more memory buses (which may each include an address bus and a data bus) may couple processor 608 to memory 602. Bus 610 may include one or more memory buses, as described below. In particular embodiments, one or more memory management units (MMUs) reside between processor 608 and memory 602 and facilitate accesses to memory 602 requested by processor 608. In particular embodiments, bus 610 includes hardware, software, or both coupling components of computing system 600 to each other.

According to particular embodiments, computing system 600 performs specific operations by processor 608 executing one or more sequences of one or more instructions contained in memory 602. For example, instructions for various portions of the methods 300, 400, and/or 500 may be contained in memory 602 and may be executed by the processor 608. Such instructions may be read into memory 602 from another computer readable/usable medium, such as static storage 604 or dynamic storage 606. In alternative embodiments, hard-wired circuitry may be used in place of or in combination with software instructions. Thus, particular embodiments are not limited to any specific combination of hardware circuitry and/or software. In various embodiments, the term “logic” means any combination of software or hardware that is used to implement all or part of particular embodiments disclosed herein.

The term “computer readable medium” or “computer usable medium” as used herein refers to any medium that participates in providing instructions to processor 608 for execution. Such a medium may take many forms, including but not limited to, nonvolatile media and volatile media. Non-volatile media includes, for example, optical or magnetic disks, such as static storage 604 or dynamic storage 606. Volatile media includes dynamic memory, such as memory 602.

Computing system 600 may transmit and receive messages, data, and instructions, including program, e.g., application code, through communications link 618 and communications interface 616. Received program code may be executed by processor 608 as it is received, and/or stored in static storage 604 or dynamic storage 606, or other storage for later execution. A database 614 may be used to store data accessible by the computing system 600 by way of data interface 612. For example, projection settings and predetermined positions of ride vehicles may be stored using a database 614. In various examples, a communications link 618 may communicate with computing components within a network.

The systems and methods described above provide a less complex and less expensive solution for AR alignment which is less visible to users within an environment. Such visual indicators may further be highly visible to AR components within an environment, such that the calibration of AR components within the environment is improved when compared to traditional AR markers.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A visual indicator assembly comprising:
a retroreflective layer; and
a diffusion layer coupled to and positioned over at least a portion of the retroreflective layer, wherein the diffusion layer reduces reflection of light from the retroreflective layer for at least one viewpoint relative to the visual indicator assembly.

2. The visual indicator assembly of claim 1, wherein the diffusion layer reduces reflection of light in a visible light spectrum.

3. The visual indicator assembly of claim 1, wherein the diffusion layer reduces reflection of light in an infrared spectrum.

4. The visual indicator assembly of claim 1, wherein the diffusion layer allows reflection of light from the retroreflective layer from at least one angle relative to the visual indicator assembly.

5. The visual indicator assembly of claim 4, further comprising a visual indicator, wherein the visual indicator is visible from the at least one angle.

6. The visual indicator assembly of claim 4, wherein the at least one angle is perpendicular to a surface of the visual indicator assembly.

7. The visual indicator assembly of claim 1, wherein the retroreflective layer comprises a retroreflective base layer and a retroreflective component layer, wherein the retroreflective base layer includes a visual indicator.

8. The visual indicator assembly of claim 7, wherein the visual indicator is an augmented reality (AR) code.

9. The visual indicator assembly of claim 1, wherein the diffusion layer is a pure-diffuse enamel layer.

10. A method of utilizing a visual indicator assembly, the method comprising:
providing a visual indicator assembly, the visual indicator assembly comprising a visual indicator including a retroreflective layer and a diffusion layer coupled to and positioned over at least a portion of the retroreflective layer, wherein the diffusion layer reduces reflection of light from the retroreflective layer for at least one viewpoint relative to the visual indicator assembly; and
illuminating the visual indicator at a first angle relative to the at least one viewpoint.

11. The method of claim 10, wherein the at least one viewpoint is at a second angle relative to the visual indicator assembly, the method further comprising masking a reflection of light from the visual indicator at the second angle.

12. The method of claim 11, wherein the first angle is perpendicular to a surface of the visual indicator assembly and the second angle is not perpendicular to the surface of the visual indicator assembly.

13. The method of claim 10, wherein illuminating the visual indicator at the first angle comprises illuminating the visual indicator with light in a visible light spectrum.

14. The method of claim 10, wherein illuminating the visual indicator at the first angle comprises illuminating the visual indicator with light in an infrared light spectrum.

15. The method of claim 10, wherein the visual indicator is visible when the visual indicator is illuminated from the first angle.

16. The method of claim 10, wherein the visual indicator is an augmented reality (AR) code.

17. The method of claim 16, further comprising aligning at least one AR component based on the AR code.

18. The method of claim 10, wherein the diffusion layer is a pure-diffuse enamel layer.

19. A method for mapping placement of one or more visual indicators within an environment, the method comprising:
identifying a light path of at least one light source within an environment;
identifying locations within the environment outside of the identified light path; and
outputting the locations as positions for the one or more visual indicators.

20. The method of claim 19, wherein the identified light path is within at least one expected viewing angle of the one or more visual indicators.
